(19) United States
(12) Patent Application Publication
(10) Pub. No.: US 2008/0163446 A1
(43) Pub. Date: Jul. 10, 2008

(54) Windshield Wiper Mechanism Connector for Mounting the End of an Arm Sideways Onto a Wiper Blade Unit

(75) Inventor: Jean-Claude Thienard, Gisors (FR)

Correspondence Address: OSHA LIANG L.L.P., 1221 MCKINNEY STREET, SUITE 2800, HOUSTON, TX, 77010, US

(73) Assignee: VALEO SYSTEMES D'ESSUYAGE, LA VERRIERE (FR)

(21) Appl. No.: 11/587,704

(22) PCT Filed: Apr. 22, 2005
(86) PCT No.: PCT/EP2005/004328

§ 371 Date: Oct. 2, 2007

(30) Foreign Application Priority Data
Apr. 26, 2004 (FR) 0404415

(51) Int. Cl. B60S 1/40

(52) U.S. Cl. 15/250.32

(57) ABSTRACT

The invention relates to a connector (10) for mounting a windshield wiper blade unit (12) on the front longitudinal end (14) of a windshield wiper arm (16), in which connector:

the connector (10) is mounted sideways onto a coupling element (20) of the wiper blade unit (12) via a transverse rod (32);

the connector (10) has a top transverse bar (38) for locking it transversely in the mounted position in which it is mounted on the coupling element (20);

the front end (14) of the arm (16) is curved back to form a U-shape that is rearwardly open; and

the connector (10) has a body (28) around which the U-shaped front end (14) of the arm (16) is engaged, and two vertical longitudinal side cheek plates (30) which are interconnected by the body (28) and between which the front end (14) of the arm (16) is received;

the connector (10) being secured dismountably to the front end (14) of the arm (16) by resilient interfitting engagement and/or by co-operation between complementary shapes;

said connector being characterized in that the body (28) and the two vertical longitudinal cheek plates (30) form a single part.

The invention relates to a connector for connecting a windshield wiper arm in the form of a U-shaped hook to a coupling element of a windshield wiper blade unit of the “flat-blade” type.

The invention relates more particularly to a connector for mounting and hinging a windshield wiper blade unit on the front longitudinal end of a windshield wiper arm about a transverse axis, said front end of the arm being curved back to form a U-shape that is rearwardly open, and that has two parallel longitudinal branches, namely a top branch and a bottom branch that are interconnected by a curved segment that is forwardly convex, in which connector:

the connector is mounted onto a coupling element of the wiper blade unit by means of a rightward transverse movement, into abutment against a left side end vertical longitudinal face of the coupling element;

the connector is hinged relative to the coupling element via a transverse rod having a right segment that is received in the coupling element and a left segment that is received in the connector;

the connector has a top transverse bar for locking it transversely in the mounted position in which it is mounted on the coupling element; and

the connector has a body around which the U-shaped front end of the arm is engaged, and two vertical longitudinal side cheek plates which are interconnected by the body and between which the front end of the arm is received;

the connector being secured dismountably to the front end of the arm by resilient interfitting engagement and/or by co-operation between complementary shapes;

In a low-height design for a windshield wiper, the hinged structure of the windshield wiper arm that carries the wiper blade proper, i.e. the squeegee or “rubber”, is omitted, and it is, for example spine members, or structural reinforcement elements analogous to spine members, that are associated with the flexible wiper blade to constitute the wiper blade unit proper, also referred to as a “flat-blade” unit.

The blade unit is mounted to be hinged relative to the end of a drive arm so as to reduce the total height of the windshield wiper.

In a design in widespread use, the windshield wiper arm consists of a metal rod whose front end is curved back to form a rearwardly open U-shape.

The front end of the arm then takes up a relatively large amount of space, and therefore, it has been proposed to mount the arm sideways onto the windshield wiper blade unit.

Document EP-A-1 323 601 describes a connector for mounting the front end of the arm sideways onto the wiper blade unit.

In that document, the connector has two side portions that are mounted on either side of the front end of the arm and that are secured together via a fastening screw.

Such assembly of the connector by means of a fastening screw is relatively complex because it requires a tool to be used to drive the screw and that tool must be positioned relative to the screw and then actuated in order to tighten the screw.

An object of the invention is to propose a connector for mounting the front end of the arm sideways onto the windshield wiper blade unit that, in order to be fastened to the front end of the arm, does not require the use of any special tool.

To this end, the invention provides a connector of the above-described type, characterized in that the body (28) and the two vertical longitudinal cheek plates (30) form a single part.

According to other characteristics of the invention:
the body of the connector is circularly cylindrical in shape, the cylindrical body is suitable for pivoting inside the front end of the arm while the front end of the windshield wiper arm is being engaged around the body, and the side cheek plates are provided with locking means for locking the connector so as to prevent it from pivoting in the front end of the arm;
the connector has a top bridge which interconnects the rear ends of the top edges of the side cheek plates, and against a bottom horizontal face of which the top branch of the front end of the arm is in upward abutment, and the facing inside vertical longitudinal faces of the cheek plates are provided with resilient lugs for locking the top branch of the front end of the arm in abutment against the bottom face of the bridge;
the bridge is offset longitudinally towards the rear of the connector relative to the body, and is extended transversely rightwards by the securing transverse bar;
the front longitudinal ends of the cheek plates are interconnected by at least one front crosspiece that forms a frontward longitudinal abutment for the curved segment of the front end of the arm;
the connector has a cap that defines a rearwardly open hollow housing which receives the front end of the arm, the body, and the cheek plates of the connector, and a right side vertical longitudinal flange of the cap is provided with an opening that co-operates with the rod to secure the connector dismountably to the front end of the arm;
the opening is provided with a constriction for locking the rod in position in the opening;
the cap has two parallel side flanges that extend mainly in a vertical longitudinal direction, and that are interconnected by a curved-back U-shaped curved wall;
the curved wall is provided with an internal groove that extends along the inside face of the curved wall and that is suitable for receiving a complementary portion of the front end of the arm;
the connector has a cover that is mounted to be hinged relative to the cheek plates about a transverse axis arranged forwards and downwards relative to the hinge axis of the wiper blade unit relative to the front end of the arm, to go between a closed position in which it longitudinally locks the front end of the arm in the engaged position in which it is engaged around the body of the connector, and an open position allowing the front end of the arm to move longitudinally relative to the body of the connector;
the cover is in the form of an upside-down L-shape, in section on a vertical longitudinal plane, and has a long branch that extends horizontally above the top branch of the front end of the arm, and a short branch that extends vertically downwards from the front longitudinal end of the long branch, in front of the curved segment of the front end of the arm;
the long branch of the cover is provided with means for locking the cover in the closed position, which means co-operate with the top branch of the front end of the arm;
the transverse bar extends transversely rightwards from the rear longitudinal end of the long branch of the cover;
the body is of longitudinally elongate oblong shape that is complementary to the front end of the arm;
the left segment of the rod is fastened to the body of the connector by molding the body of the connector around the left segment of the rod; and
the connector is made integrally in one piece by molding a plastics material.

Other characteristics and advantages of the invention will appear on reading the following detailed description which, in order to make it easier to understand, is given with reference to the accompanying figures, in which:

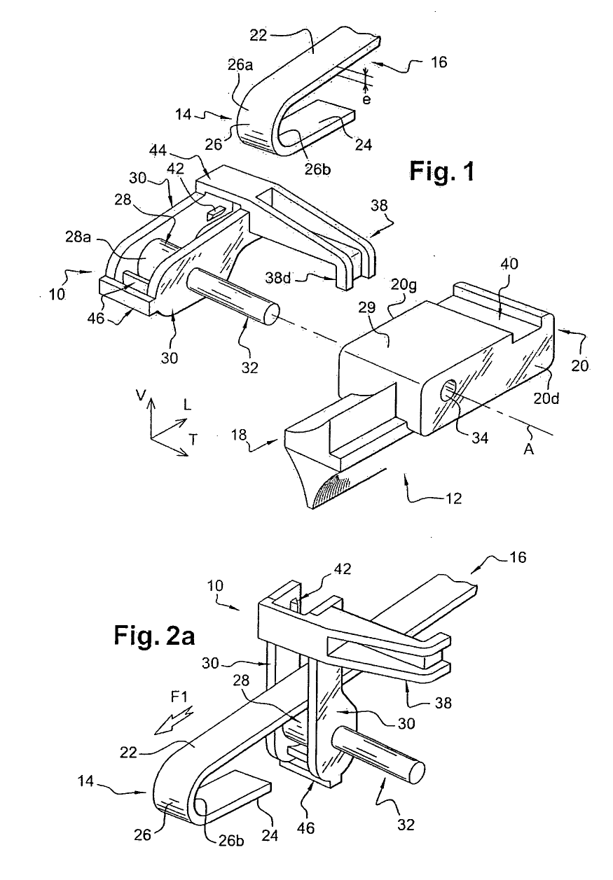

FIG. 1 is a diagrammatic perspective view of a connector of the invention before it is mounted on the arm and on the wiper blade unit;

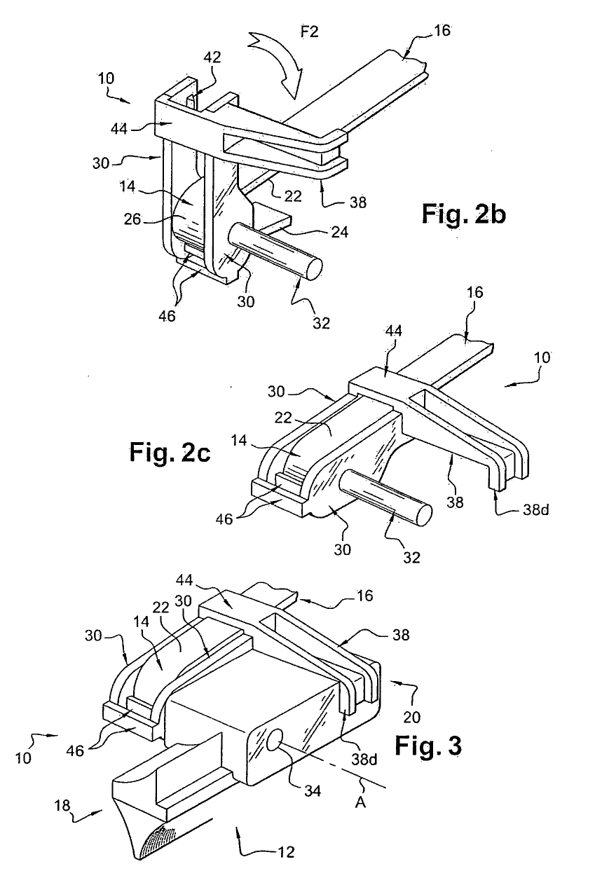

FIGS. 2A to 2C are views similar to the FIG. 1 view, showing different stages in mounting the connector on the end of the drive arm;

FIG. 3 is a view similar to the FIG. 1 view, showing the connector of the invention as connecting the drive arm to the wiper blade unit;

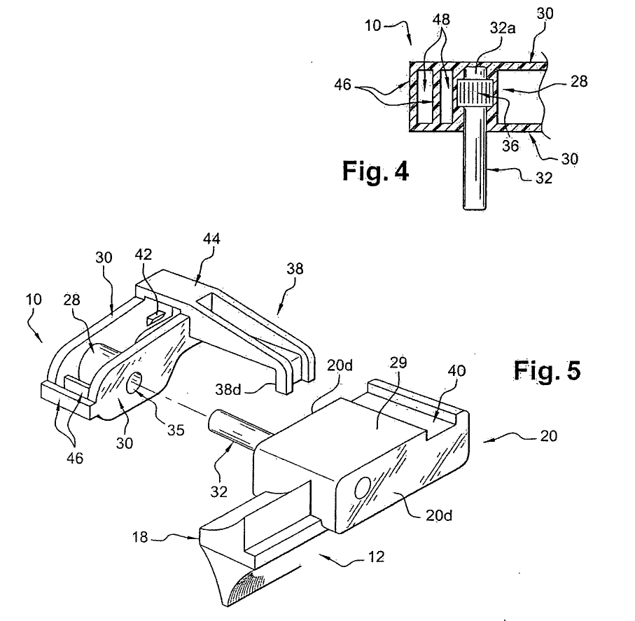

FIG. 4 is a horizontal section view of the connector shown in FIG. 1, showing how the transverse rod is mounted in the body of the connector;

FIG. 5 shows a connector similar to the connector shown in FIG. 1, with the transverse rod being carried by the coupling element of the wiper blade unit;

FIG. 6 is a diagrammatic exploded perspective view of another embodiment of the connector, which has a cap-shaped portion;

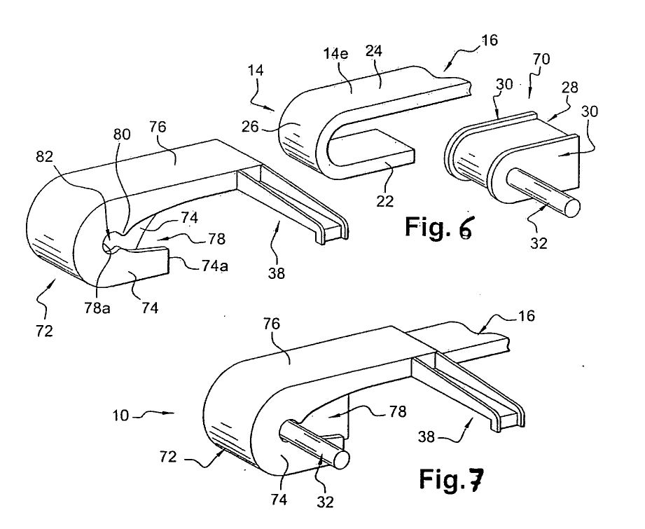

FIG. 7 is a view similar to the FIG. 6 view, showing the connector in the position in which it is mounted around the end of the arm;

FIG. 8 is a section view on transverse vertical plane of the connector shown in FIG. 7;

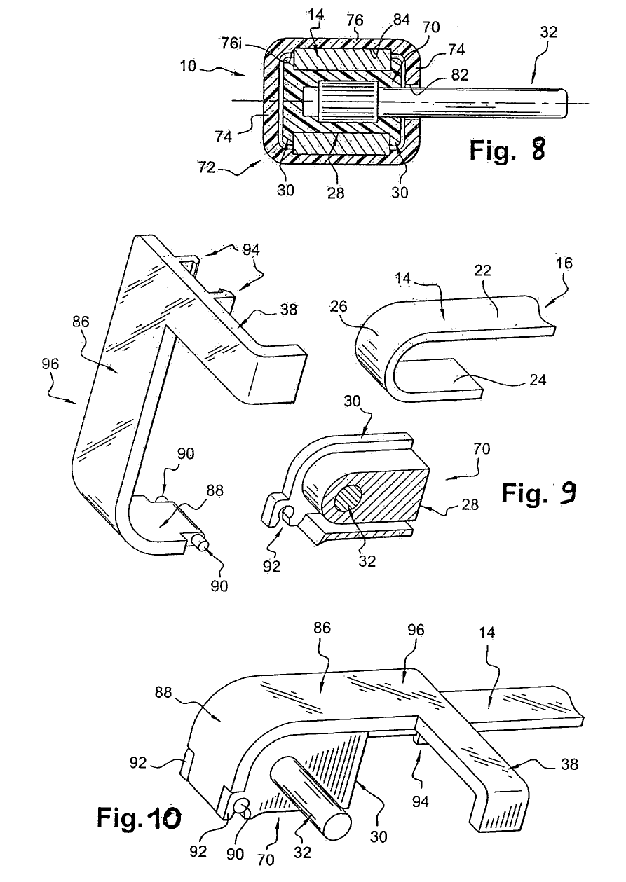

FIG. 9 is a diagrammatic exploded perspective view of another embodiment of the connector that includes a cover-shaped portion; and

FIG. 10 is a view similar to the FIG. 9 view, showing the connector in the position in which it is mounted around the end of the arm.

For the description of the invention, the vertical, longitudinal, and transverse directions are adopted in non-limiting manner as defined in the frame of reference V, L, T indicated in the figures.

The front-to-rear direction is also adopted as being the longitudinal direction from left to right with reference to FIG. 1.

In the description below, elements that are identical, similar, or analogous are designated by like reference numerals.

FIG. 1 shows a connector 10 making it possible to mount a windshield wiper blade unit 12 on the front longitudinal end 14 of a windshield wiper arm 16. The connector 10 also makes it possible to hinge the wiper blade unit 12 relative to the front end 14 of the arm 16, about a transverse axis A.

The windshield wiper blade unit 12 is a wiper blade unit of the “flat-blade” type, and, to this end, it comprises a wiper blade proper 18 associated with structural elements (not shown), and a coupling element 20 arranged longitudinally substantially in the middle of the wiper blade proper 18, the connector 10 being mounted on said coupling element.

The front end 14 of the arm 16 is a hook-shaped end that has a rearwardly open U-shape, and it thus has two parallel longitudinal branches, namely a top branch 22 and a bottom branch 24, which branches are interconnected by a curved front segment 26 that is forwardly convex.

In order to enable the windshield wiper blade unit 12 to be mounted on the front end 14 of the arm 16, the connector 10 is suitable for being dismountably secured to the front end 14 of the arm 16, and it is suitable for being hinged relative to the coupling element 20 about the transverse axis A.

In order to enable it to be secured to the front end 14 of the arm 16, the connector 10 has a body 28 about which the front end 14 of the arm 16 is engaged, so that a front face 28a of the body 28 bears longitudinally forwards against the rear transverse face 26b of the curved segment 26.

The connector 10 also has two vertical longitudinal side cheek plates 30 which are interconnected via the body 28, and between which the front end 14 of the arm 16 is received when the connector 10 is secured to the front end 14 of the arm 16.

In order to enable mounting to be simple and easy, the two vertical longitudinal side cheek plates 30 and the body 28 form a single part. This part can be a one-piece integrally formed part. By way of a variant embodiment, the body 28 is fastened permanently to the vertical longitudinal side cheek plates 30. In particular, it is formed integrally with the vertical longitudinal side cheek plates 30.

The connector 10 is mounted sideways onto the coupling element 20, and, in this example, onto the left side of the coupling element 20, so that it bears against a left vertical longitudinal face 20g of the coupling element 20.

The connector 10 is hinged relative to the coupling element 20 by means of a transverse rod 32 that is received in part in a complementary housing in the body 28, and in part in a complementary housing 34 in the coupling element 20.

The transverse rod 32 is cylindrical and is circular in section, so as to constitute the hinge axis A. As can be seen in particular in FIG. 1, a left segment of the rod 32 is secured to the connector, and the right segment of the rod is received in the housing 34.

For this purpose, as can be seen in FIG. 4, the left transverse end 32g of the rod 32 is secured to the connector 10 by overmolding the body 28 of the connector 10 around the left transverse end 32g of the rod 32, and the rod is provided with a fluted element 36 preventing the rod 32 from moving transversely relative to the connector 10.

However, by way of a variant embodiment of the transverse rod 32, shown in FIG. 5, the right segment of the rod 32 is secured to the coupling element 20, and the left segment of the rod 32 is pivotally received in an associated housing 35 in the body 28 of the connector 10.

The connector 10 also has a top transverse bar 38 which extends transversely rightwards from the right cheek plate 30 and whose free right transverse end 38d is curved over downwards.

When the connector 10 is mounted on the coupling element 20, the transverse bar 38 extends above the coupling element 20, by straddling it, so that its right transverse end 38d bears against the right end vertical longitudinal face 20d of the coupling element 20, so as to prevent the connector 10 from moving transversely leftwards relative to the coupling element 20.

Finally, the top face 20s of the coupling element 20 is provided with a transverse groove 40 that opens out upwards, and that is suitable for receiving the transverse bar 38 in part.

As mentioned above, the connector 10 has a body 29 and side cheek plates 30 for the purpose of mounting it on the front end 14 of the arm 16.

The connector 10 is also provided with means for securing it to the front end 14 of the arm 16.

In accordance with the invention, said means for securing the connector 10 to the front end 14 of the arm 16 consist of means for securing by resilient interfitting and by co-operation of complementary shapes.

In a first embodiment shown in FIGS. 1 to 5, the securing means include lugs 42 that extend transversely towards the inside of the connector 10 from the facing inside vertical longitudinal faces 30i of the cheek plates 30, and that are arranged longitudinally behind the body 28.

The securing means further include a top bridge 44 that interconnects the respective longitudinal top edges 30s of the cheek plates 30, and that is arranged longitudinally above the lugs 42.

In addition, the body 28 of the connector 10 is circularly cylindrical in shape so as to enable the connector 10 to pivot relative to the front end 14 of the arm 16 when the front end 14 of the arm 16 is engaged around the body 28.

The lugs 42 and the top bridge 44 define a housing in which the top branch 22 of the front end 14 of the arm 16 is received in part, in a manner such as to prevent the connector 10 from moving in rotation in the front end 14 of the arm 16.

Finally, the connector 10 is prevented from moving longitudinally rearwards relative to the front end 14 of the arm 16 by a crosspiece 46 that comes into abutment rearwards against the convex front face 26a of the curved segment 26.

As can be seen in FIG. 2a, the connector 10 is mounted on the front end 14 of the arm 16 firstly by engaging the front end 14 of the arm 16 around the body 28 of the connector 10. For this purpose, it is necessary firstly to pivot the connector 10 through an angle of 90° relative to its mounted position.

Then, the connector 10 is moved in translation forwards relative to the front end 14 of the arm 16, as indicated by arrow F1, by engaging the body 28 between the branches 22, 24 of the front end 14 of the arm 16, until the body 28 of the connector 10 is in abutment against the rear concave face 26b of the curved segment 26.

Then, as can be seen in FIG. 2b, the connector 10 is caused to pivot relative to the front end 14 of the arm 16, as indicated by arrow F2, until the top branch 22 of the front end 14 is in abutment against the top bridge 44, as shown in FIG. 2c.

The lugs 42 are adapted to retract transversely while the connector 10 is pivoting, so as to enable the top branch 22 to pass between the lugs 42, and then to return resiliently to their initial positions once the top branch 22 of the front end 14 is in abutment against the top bridge 44, thereby achieving the interfitting engagement of the top branch 22 of the front end 14 between the top bridge 44 and the lugs 42.

In a preferred embodiment, the top bridge 44 is arranged at the same longitudinal level as the transverse bar 38, so that the transverse bar 38 extends the top bridge 44 transversely rightwards.

In a variant embodiment, the connector is suitable for connecting the wiper blade unit 12 to a front end 14 of an arm 16 that can have different sizes, e.g., as shown in this example, the thickness “e” of the branches 22, 24 of the front end 14 of the arm 16 can have two possible values.

For this purpose, as can be seen in FIG. 4, the connector has two crosspieces 46 that, in association with the body 28, define two housings 48, each of which is associated with a respective size of front end 14 of an arm 16.

FIGS. 6 to 8 show another embodiment of the connector 10 in which the body 28, the cheek plates 30, and the transverse rod 32 form a first portion 70 of the connector 10, about which the front end 14 of the arm 16 is engaged.

In this other embodiment, the connector 10 has a hollow cap-shaped second portion 72 that covers the front end 14 of the arm 16 and the first portion 70 of the connector 10, while securing the connector 10 to the front end 14 of the arm 16.

The cap 72 has two side vertical longitudinal flanges 74 between which the cheek plates 30 are received, and which are themselves interconnected by a curved wall 76 that is U-shaped and that covers the outside face 14e of the front end 14 of the arm 16.

The right side flange 74 of the cap 72 is further provided with a longitudinal opening 78 which opens out in a rear vertical edge 74a of the flange 74, and in which the transverse rod 32 is engaged when the cap 72 is mounted around the front end 14 of the arm 16 and around the first portion 70 of the connector 10.

The cap 72 is locked in the position in which it is mounted around the front end 14 of the arm 16 and around the first portion 70 of the connector 10 by the transverse rod 32 being engaged in interfitting manner in the opening 78.

For this purpose, the opening 78 is provided with a constriction 80 which is suitable for deforming elastically so as to allow the transverse rod 32 to pass through it while the cap 72 is being mounted, and so as to form a rearward abutment for the transverse rod 32.

The constriction thus defines a front housing 82 in the opening 78, into which housing the transverse rod 32 is engaged resiliently in order to lock the cap 72, and thus the connector, in the position in which it is mounted on the front end 14 of the arm 16.

In a preferred embodiment shown in FIG. 8, the curved wall 76 of the of the cap 72 is provided with an internal groove 84 that extends along its inside face 76i, while matching the curved profile of the curved portion 76, and that is suitable for receiving an outside portion of the front end 14 of the arm 16.

Finally, the transverse bar 38 is formed integrally with the cap 72, and it extends transversely rightwards from the rear top end of the curved wall 76.

FIGS. 9 and 10 show yet another embodiment of the connector 10 of the invention. In this embodiment, the connector also has a first portion 70 that is made up of the body 28 of the cheek plates 30, and of the transverse rod 32, and that is suitable for being engaged in the front portion 14 of the arm 16 by being moved longitudinally forwards.

The connector 10 also has a cover 96 which is mounted to pivot relative to the first portion 70 between an open first position in which it enables the first portion 70 to be engaged in the front end 14 of the arm 16, and a locking second position for locking the first portion in the engaged position in which it is engaged in the front end 14 of the arm 16.

In this example, the cover 96 consists of a curved L-shaped strip whose long branch 86 extends horizontally above the top branch 22 of the front end 14 of the arm 16, and whose short branch 88 extends vertically in front of the curved segment 26 of the front end 14 of the arm 16, when the cover is in the locking position.

The cover 96 is mounted to pivot through 90° forwards relative to the first portion 70 of the connector 10, about a second transverse axis B which is offset longitudinally and vertically relative to the hinge axis A, so that, when the cover 96 is in the open position, the long branch 86 extends vertically upwards from the short branch as shown in FIG. 9.

In this example, the second transverse axis B is arranged at a front bottom corner of the first portion 70 of the connector 10.

In this example, the cover 96 is hinged relative to the first portion 70 by means of transverse fingers 90 on the free end 88a of the short flange 88, which fingers are received in complementary cylindrical housings 92 in each cheek plate 30 of the connector 10.

In accordance with the invention, the connector 10 is provide with locking means for locking the cover 96 in the locking position in which it locks the first portion 70 in the engaged position in which it is engaged in the front end 14 of the arm 16 by resilient interfitting engagement.

In this example, said locking means consist of resilient catches or hooks 94 that extend vertically downwards from the bottom horizontal face 86i of the long branch 86 when the cover 96 is in the locking position, and that are suitable for co-operating with the top branch 22 of the front end 14 of the arm 16 to lock the cover 96 so as to prevent it from pivoting about the second transverse axis B.

The hooks 94 are distributed transversely on either side of the long branch 86, so that each hook 94 extends on one side of the top branch 22 of the front end 14 of the arm 16.

The hooks 94 are made of an elastic material and the curved free end of each them has a ramp shaped portion, thereby enabling the hooks 94 to retract while the cover 96 is moving towards its locking position.

Finally, the transverse bar 38 is formed integrally in one piece with the cover 96 and it extends transversely rightwards from the free rear end 86a of the long branch 86 of the cover 96.

1. A connector for mounting and hinging a windshield wiper blade unit on the front longitudinal end of a windshield wiper arm about a transverse axis, said front end of the arm being curved back to form a U-shape that is rearwardly open, and that has two parallel longitudinal branches, namely a top branch and a bottom branch that are interconnected by a curved segment that is forwardly convex, in which connector:
the connector is mounted onto a coupling element of the wiper blade unit by means of a rightward transverse movement, into abutment against a left side end vertical longitudinal face of the coupling element;
the connector is hinged relative to the coupling element via a transverse rod having a right segment that is received in the coupling element and a left segment that is received in the connector;
the connector has a top transverse bar for locking it transversely in the mounted position in which it is mounted on the coupling element; and
the connector has a body around which the U-shaped front end of the arm is engaged, and two vertical longitudinal side cheek plates which are interconnected by the body and between which the front end of the arm is received;
the connector being secured dismountably to the front end of the arm by resilient interfitting engagement and/or by co-operation between complementary shapes;
said connector being characterized in that the body and the two vertical longitudinal cheek plates form a single part.

2. A connector according to the preceding claim, in which the body of the connector is circularly cylindrical in shape, in that the cylindrical body is suitable for pivoting inside the front end of the arm while the front end of the windshield wiper arm is being engaged around the body, and in that the side cheek plates are provided with locking means for locking the connector so as to prevent it from pivoting in the front end of the arm.

3. A connector according to the preceding claim, characterized in that it has a top bridge which interconnects the rear ends of the top edges of the side cheek plates, and against a bottom horizontal face of which the top branch of the front end of the arm is in upward abutment, and in that the facing inside vertical longitudinal faces of the cheek plates are provided with resilient lugs for locking the top branch of the front end of the arm in abutment against the bottom face of the bridge.

4. A connector according to the preceding claim, in which the bridge is offset longitudinally towards the rear of the connector relative to the body, and is extended transversely rightwards by the securing transverse bar.

5. A connector according to claim 2, characterized in that the front longitudinal ends of the cheek plates are interconnected by at least one front crosspiece that forms a frontward longitudinal abutment for the curved segment of the front end of the arm.

6. A connector according to claim 1, characterized in that it has a cap that defines a rearwardly open hollow housing which receives the front end of the arm, the body, and the cheek plates of the connector, and in that a right side vertical longitudinal flange of the cap is provided with an opening that co-operates with the rod to secure the connector dismountably to the front end of the arm.

7. A connector according to the preceding claim, characterized in that the opening is provided with a constriction for locking the rod in position in the opening.

8. A connector according to the preceding claim, characterized in that the cap has two parallel side flanges that extend mainly in a vertical longitudinal direction, and that are interconnected by a curved-back U-shaped curved wall.

9. A connector according to the preceding claim, characterized in that the curved wall is provided with an internal groove that extends along the inside face of the curved wall and that is suitable for receiving a complementary portion of the front end of the arm.

10. A connector according to claim 1, characterized in that it has a cover that is mounted to be hinged relative to the cheek plates about a transverse axis arranged forwards and downwards relative to the hinge axis of the wiper blade unit relative to the front end of the arm, to go between a closed position in which it longitudinally locks the front end of the arm in the engaged position in which it is engaged around the body of the connector, and an open position allowing the front end of the arm to move longitudinally relative to the body of the connector.

11. A connector according to the preceding claim, characterized in that the cover is in the form of an upside-down L-shape, in section on a vertical longitudinal plane, and has a long branch that extends horizontally above the top branch of the front end of the arm, and a short branch that extends vertically downwards from the front longitudinal end of the long branch, in front of the curved segment of the front end of the arm.

12. A connector according to the preceding claim, characterized in that the long branch of the cover is provided with means for locking the cover in the closed position, which means co-operate with the top branch of the front end of the arm.

13. A connector according to claim 11, characterized in that the transverse bar extends transversely rightwards from the rear longitudinal end of the long branch of the cover.

14. A connector according to claim 6, characterized in that the body is of longitudinally elongate oblong shape that is complementary to the front end of the arm.

15. A connector according to claim 1, characterized in that the left segment of the rod is fastened to the body of the connector by molding the body of the connector around the left segment of the rod.

16. A connector according to claim 1, characterized in that it is made integrally in one piece by molding a plastics material.

17. A connector according to claim 3, characterized in that the front longitudinal ends of the cheek plates are interconnected by at least one front crosspiece that forms a frontward longitudinal abutment for the curved segment of the front end of the arm.

18. A connector according to claim 4, characterized in that the front longitudinal ends of the cheek plates are interconnected by at least one front crosspiece that forms a frontward longitudinal abutment for the curved segment of the front end of the arm.

19. A connector according to claim 12, characterized in that the transverse bar extends transversely rightwards from the rear longitudinal end of the long branch of the cover.
